(19) United States
(12) Patent Application Publication
(10) Pub. No.: US 2013/0138586 A1
(43) Pub. Date: May 30, 2013

(54) SERVICE GOAL INTERPRETING APPARATUS AND METHOD FOR GOAL-DRIVEN SEMANTIC SERVICE DISCOVERY

(71) Applicants: Yu-Chul JUNG, Daejeon-si (KR); Hyun-Joo BAE, Daejeon-si (KR); Byung-Sun LEE, Daejeon-si (KR)

(72) Inventors: Yu-Chul JUNG, Daejeon-si (KR); Hyun-Joo BAE, Daejeon-si (KR); Byung-Sun LEE, Daejeon-si (KR)

(73) Assignee: Electronics and Telecommunications Research Instit ute, Daejeon-si (KR)

(21) Appl. No.: 13/585,114

(22) Filed: Aug. 14, 2012

(30) Foreign Application Priority Data
Nov. 30, 2011 (KR) 10-2011-0126927

(51) Int. Cl. G06F 15/18

(52) U.S. Cl. 706/12; 706/14

(57) ABSTRACT

A service goal interpreting apparatus for goal-driven semantic service discovery is provided. The service goal interpreting apparatus includes a goal interpretation unit that interprets a goal of at least one service or application provided on the Web, and a goal registration unit that registers the goal interpreted by the goal interpretation unit in a service registry.

### CROSS-REFERENCE TO RELATED APPLICATION

This application claims the benefit under 35 U.S.C. §119(a) of Korean Patent Application No. 10-2011-0126927, filed on Nov. 30, 2011, the entire disclosure of which is incorporated herein by reference for all purposes.

### BACKGROUND

1. Field

The following description relates to a web service technique, and more particularly, to an apparatus and method for interpreting goals of web services.

2. Description of the Related Art

As the provision of open API type web services and the variety of Apps mounted in smart phones continue to increase, the ability to search for services or Apps that rate high in user satisfaction and the ability to provide those services or Apps to users have emerged as very important issues. Examples of web service techniques that address these issues include automatic ontology construction for web services, goal annotations for web services, utilization of functionality, and a goal-driven service discovery.

First, the automatic ontology construction for web services is an algorithm that has been recently proposed to automatically construct an ontology implemented by engineers. Examples of the proposed algorithm are a skeleton ontology, a service ontology, and a domain ontology.

The skeleton ontology is configured using a document including the largest number of critical classes from among searched WSDL documents as a basic ontology for implementing semantic web services.

The service ontology is generated by expanding the skeleton ontology using the remaining WSDL documents except a “base-WSDL document” utilized to generate the skeleton ontology. In this instance, “subject-object relation between classes” and instances are defined and considered.

The domain ontology is an ontology that is completed when the service ontology is applied to all of the WSDL documents.

In 2011, a method of automatically expanding an ontology from a WSDL document and a text descriptor for web services was proposed. Here, based on the fact that the web services are mainly constituted of WSDL documents and free text descriptors, a method of expanding the ontology in such a manner that concepts derived from a TF (Term Frequency)*IDF (Inverse Document Frequency) method and a web context generation technique are verified using the free text descriptor was developed.

However, in existing actual web services, there are many cases in which the free text descriptors are in a vacuum state or are very poorly described. Accordingly, in order to adopt the above-described technique, there is a limitation that the WSDL document is required to be described in a very detailed and accurate manner.

Next, as for the goal annotations for web services, a framework of providing goal annotation for a process model has been proposed so as to more meaningfully reinforce process knowledge, and there is a case in which a semantic service discovery and a heterogeneous process model are easily reused with reference to the ontology at the time of a query process.

In addition, in a case of a web service modeling ontology (WSMO), goal is adopted as one of main components together with the ontology, a mediator, and web services, and is described as a web service markup language (WSML) to thereby establish a consistent semantic processing framework.

For automation of web service annotation, automation of semantic annotation has been attempted using a variety of mechanical learning methods such as a string matcher, a structural matcher, and a synonym finder in an METEOR-S, but this has a disadvantage that clear rules concerning semantic mapping between existing ontologies are required to be declared.

However, since both the above-described two cases are tasks which are required to be described in accordance with a format defined in advance as well as needing technical expertise, high-level manual labor by domain experts is required. However, practically, the goal of all web services/services is not described in a consistently defined format.

As the most similar research related with the goal annotation, research into the discerning of intentions of queries based on “verb+noun” for effective web searching has been conducted. In this research, snippet contents of web pages (i.e., URL) visited by a user are interpreted and classified using a supervised learning technique. In this instance, the knowledge base which has been constructed based on resources of eHow.com including a large number of how-to documents is used.

It is easy to extract explicit goals in a case of web pages or services including sufficient descriptors, but otherwise, it is very difficult to estimate the goals. In addition, research into techniques for automating the goal annotations for web services has scarcely been conducted.

In the utilization of functionality, services having similar functionality are clustered, using clustering techniques, as the same cluster from among web services which are registered in the registry based on contents of interface, operation, input, and output parts, by interpreting WSDL documents. For the clustering, a C-mean algorithm, a fuzzy c-mean algorithm which is modification of the C-mean algorithm, or the like, is basically used.

The clustering performed using functionality based on interface-operation-input-output (IOIO) selects a registry suitable for a corresponding query, and supports the semantic service discovery when multiple registries under a distribution environment are present.

In contrast, when configuring services satisfying goals of users by composing a plurality of unit web services, considering the functionality (represented as “action+object”) helps in finding services satisfying intensions of the users.

In functional semantic services, an ontology is specially constructed for each domain, and the constructed ontology is modeled by a service relation graph (SRG) so as to be utilized in web service combination fields. This is composed of a data dependency graph between services, an action graph indicating relationships between domain actions, mapping between these two graphs, and the like. For example, a relationship diagram of the SRG is configured such that, within a large goal domain such as travel, verbs such as “search”, “provide”, “inform”, “calculate”, “convert”, and the like are associated with objects such as “address”, “province”, “capital”, “city”, “mile”, “km”, “phone number”, and the like. This is significantly effective when recommending, to actual users, detailed services required in a process of planning and reserving travel. Consequently, when the existing web services can be automatically annotated by function or goal which is represented as a verb+noun clause, new opportunities may be created in the semantic service discovery and semantic service combination fields.

In the goal-driven service discovery, semantic service matching considering relevance and importance has been attempted by adopting IR techniques, is performed by calculating importance considering a structure as well as descriptions of services, and is one of effective search techniques for services which have been described in a WSDL format.

WordNet has been adopted for processing synonyms; however, there is a limitation on the WordNet when interpreting web services in terms of goals, and it is difficult to reflect characteristics of the existing services in the WordNet.

### SUMMARY

The following description relates to an adaptive goal interpreting apparatus and method, which may interpret, in terms of goals, contents of descriptors of WSDL documents and services created.

The following description relates to a goal-driven semantic service discovery apparatus and method which may search for services satisfying goals of users while corresponding to queries or the goals of the users with respect to all services which are search targets.

In one general aspect, there is provided an adaptive service goal interpreting apparatus for goal-driven semantic service discovery, including: a goal interpretation unit that interprets a goal of at least one service or application provided on the Web; and a goal registration unit that registers the goal interpreted by the goal interpretation unit in a registry.

In another general aspect, there is provided a goal-driven semantic service discovery apparatus, including: a goal interpretation unit that performs interpretation on a goal of a user based on contents of an input query of the user; and a goal-driven service discovery unit that searches for services satisfying the goal of the user on which the interpretation is performed from a plurality of service registries.

In still another general aspect, there is provided an adaptive service goal interpreting method, including: interpreting goals of web services or applications when a description part of a file or a service description text is provided; and registering the goals of the web services or the applications in a service registry as additional meta-information describing each of the services or the applications.

Other features and aspects will be apparent from the following detailed description, the drawings, and the claims.

### BRIEF DESCRIPTION OF THE DRAWINGS

FIG. 1 is a configuration diagram of a system of interpreting or matching web service goals for supporting goal-driven semantic service discovery according to a preferred embodiment of the present invention;

FIG. 2 is a diagram for explaining implicit expression extraction according to a preferred embodiment of the present invention;

FIG. 3 is a diagram for explaining cluster interpretation according to a preferred embodiment of the present invention;

FIG. 4 is a diagram for describing in detail a goal-driven service discovery apparatus according to a preferred embodiment of the present invention;

FIG. 5 is a detailed configuration diagram illustrating a goal interpretation unit according to a preferred embodiment of the present invention;

FIG. 6 is a diagram illustrating an example of a goal ontology;

FIG. 7 is a flowchart for explaining an adaptive service goal interpreting method according to a preferred embodiment of the present invention; and

FIG. 8 is a flowchart for explaining a goal-driven semantic discovery method according to a preferred embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, preferred embodiments of the present invention will be described in detail with reference to accompanying drawings.

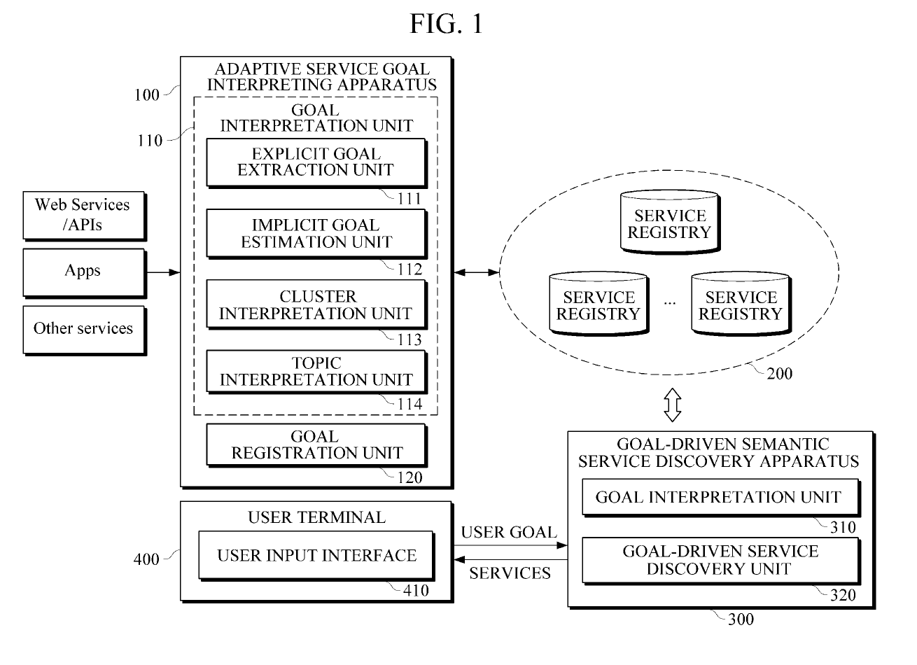

FIG. 1 is a configuration diagram of a system of interpreting or matching web service goals for supporting goal-driven semantic service discovery according to a preferred embodiment of the present invention.

Referring to FIG. 1, an adaptive service goal interpreting apparatus 100 is organically interconnected with a distributed or centralized service registry 200 to be utilized, and a goal-driven service discovery apparatus 300 searches for services satisfying goals with respect to a plurality of service registries 200. Here, in the service registry 200, a variety of meta-information of web services including goals interpreted for the goal-driven semantic service discovery is registered. That is, a result of interpreting an adaptive service goal is more detailed information than annotation information of each service, and is maintained and managed in the service registry 200 in order to be used.

The adaptive service goal interpreting apparatus will be described below.

The adaptive service goal interpreting apparatus 100 interprets goals by interpreting text describing services, and registers the interpreted goals in the service registry 200.

Services provided on the Web are mainly described in two formats. First, services which are described based on a specific standard (e.g., WSDL (web service description language) or WSMO (web service modeling ontology)) may be given. Second, services which are described by an author registering corresponding services without a specific reference may be given.

Here, in most cases of these services, with the exception of the service described based on the WSMO, input and output information of a provided web service and a description of the service itself are given without particular consideration of a goal of the service.

In addition, although the services are described using the WSDL, the WSMO, and the like, a deviation in a degree of detail of the descriptions is very large, and a type, a goal, and the like of the service are not accurately described. Accordingly, as for the goal-driven service interpretation, a goal of a corresponding service may be estimated by fully utilizing characteristics of a description part of the corresponding service even when the goal is not described in detail.

For this, the adaptive service goal interpreting apparatus 100 according to the embodiment of the present invention includes a goal interpretation unit 110 that interprets a goal of at least one service or application provided on the Web, and a goal registration unit 120 that registers the goal interpreted by the goal interpretation unit 110 in a service registry 200.

The goal interpretation unit 110 includes four detailed interpretation modules to interpret service goals for goal annotations.

Referring to FIG. 1, the goal interpretation unit 110 includes an explicit goal extraction unit 111, an implicit goal estimation unit 112, a cluster interpretation unit 113, and a topic interpretation unit 114. These interpret service descriptions, which are generally composed of an operation part and a description part, in a structured and contextual manner.

Although not shown, the explicit goal extraction unit 111 performs separate interpretation with respect to each of the operation part and the description part which are included in the service descriptions. However, web services concerning REST or JSON where WSDL does not exist perform interpretation only with respect to the description part.

The operation part is named in such a manner as to be easily acquired as a goal of a “verb+noun clause” level by processing a title/name part. Accordingly, the acquisition may be possible through simple character string parsing.

Results of explicit goal extraction acquired in a WSDL operation part are very effectively used in estimating a fine-grained topic category.

Potential goals found within the estimated topic category are utilized as candidates at the time of goal estimation.

The explicit goal extraction is commonly performed with respect to the description part regardless of web service description formats, and when it fails, cluster interpretation and implicit goal estimation with respect to implicit expressions are performed.

Only when a goal (or query) input by a user is converted into a “verb+noun clause” format using the description part, the description part is primarily processed in an explicit manner. For this, a part-of-speech (POS) tagger for interpreting a morpheme and a chunker for processing a word clause are used. When converting the input goal into the “verb+noun clause” format by interpreting a morpheme, there are cases in which there is no verb and only nouns in the input goal.

The implicit goal estimation unit 112 converts/estimates implicitly expressed user goals which into/as explicit expressions.

There are many cases in which the description part where a function of a corresponding service is explained is narratively described without being explicitly expressed in the “verb+noun clause” format, or described based on simple feature points. In this manner, when the implicitly expressed user goals are converted/estimated into/as the explicit expressions, effective service interpretation is achieved. However, intended goals may be different for each user, and therefore, a plurality of goals having the highest probability are selected, and then the selected goals are presented for final selection.

In calculating the probability, a co-occurrence probability between two words based on a large amount of corpora may be used. For example, a probability that two words appear together is (“buy”, “car”)=0.52 and (“take”, “tour”)=072.

Here, as a most frequently utilized method, a point-wise mutual information using information retrieval (PMI-IR) techniques in which a probability that two words simultaneously appear is obtained through search engines such as Yahoo, Google, Bing, and the like may be given. When using the search engines, various candidates may be presented, and in order to limit the candidates, a large number of documents corresponding to a specific domain may be collected to thereby construct a corpus.

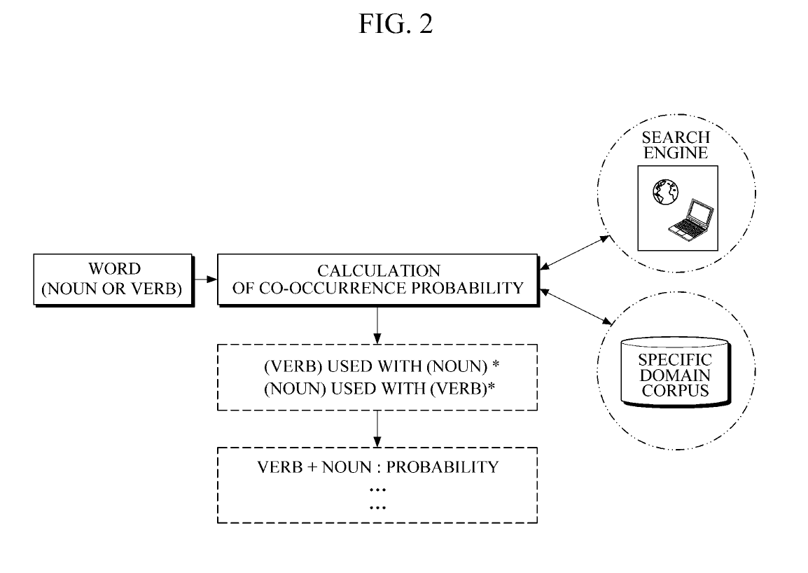

FIG. 2 is a diagram for explaining implicit expression extraction according to a preferred embodiment of the present invention.

Referring to FIG. 2, a word which is paired with an input word (noun or verb) may be acquired using search engines or a corpus of a specific domain with respect to the input word, and top k words aligned based on a probability when configuring the pair are derived as a result of goal estimation with respect to an implicit expression. However, in order to accurately extract a verb+noun clause, morpheme interpretation and chunking techniques of natural language processing are used.

Referring again to FIG. 2, the cluster interpretation unit 113 collects services for providing similar services as a cluster of each of the services to thereby configure a cluster for all similar services, and then extracts representative goals from among goals of the services existing within each cluster.

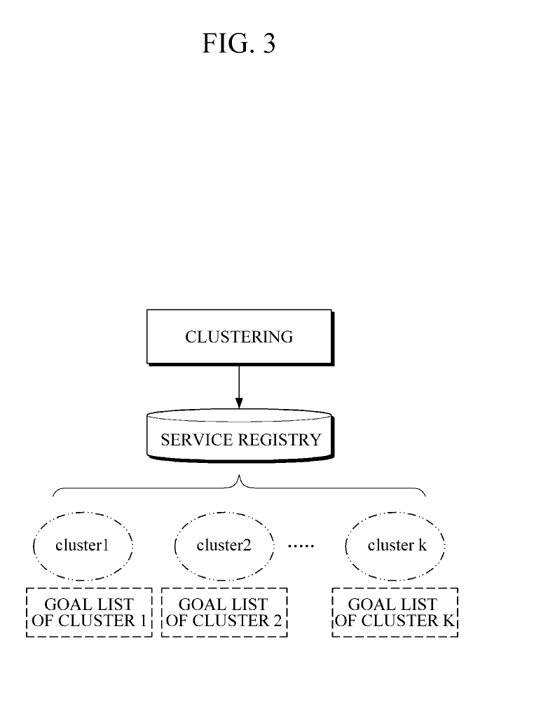

FIG. 3 is a diagram for explaining cluster interpretation according to a preferred embodiment of the present invention.

Referring to FIG. 3, when clustering is performed using text included in description parts of services existing in a service registry as inputs, a large number of clusters which are classified into similar services are generated. In this instance, services which succeed in explicit goal extraction may turn up in each cluster, and services which fail in explicit goal extraction may exist too. However, goals may be shared between services belonging to the same cluster. A goal list of each cluster is obtained by collecting, for each of corresponding classified clusters, results of goal extraction with respect to explicit expressions for each service and goal estimation with respect to implicit expressions for each service. By performing cluster interpretation, goals of adjacent similar services which are not explicitly extracted or not implicitly estimated may be obtained.

In the past, a large amount of research into general document clustering was conducted; however, in recent years, clustering become Twitter, Facebook data generated by users, so that research into clustering techniques performed with respect to very short text has been conducted and compared.

K-mean, single value decomposition (SVD), affinity propagation, and the like have been compared, and description parts of services correspond to the short text. In order to actually implement high-performance clustering, appropriate techniques for calculating a distance between a target text and a corresponding cluster are required to be selected, and at present, a jaccard-based distance calculating technique is known to be more effective than a cosine-based distance calculating technique at the time of using a K-mean technique.

Referring again to FIG. 1, the topic interpretation unit 114 basically interprets text within a corresponding document regardless of web service specification described in a WSDL format or services (for example, REST APIs) in which only description is given, and discerns a topic of a corresponding service. Accordingly, goals of services may be selected and limited within a range of the discerned topic.

For careful topic interpretation, open directory project (ODP, www.dmoz.org), wikipedia (www.wikipedia.org), and a large amount of category knowledge having a classification system may be utilized. Alternatively, a sufficient amount of training data is required to be arbitrarily provided for each topic category in order to implement a topic classifier.

Text of the description parts of services have large deviations for each service. There are cases in which sufficient descriptions of 50 words or more are given, or descriptions of 5 words or less are given. Accordingly, a technique in which topic interpretation is performed on short samples of text such as in Twitter, commercials, and the like may be applied. As for this technique, an explicit semantic analysis (ESA) method to which a centroid classifier based on a vector space model (VSM) is applied is primarily performed, and a method in which topics are more accurately classified using a supporting vector machine (SVM) that is one of machine learning techniques is secondarily performed.

Next, the goal-driven semantic service discovery apparatus 300 will be described in detail.

Referring again to FIG. 1, the goal-driven semantic service discovery apparatus 300 includes a goal interpretation unit 310 and a goal-driven service discovery unit 320.

The goal interpretation unit 310 performs interpretation on a goal of a user based on contents of an input query of the user. The goal-driven service discovery unit 320 searches for services satisfying the goal of the user on which the interpretation is performed by the goal interpretation unit 310, from a plurality of service registries 200.

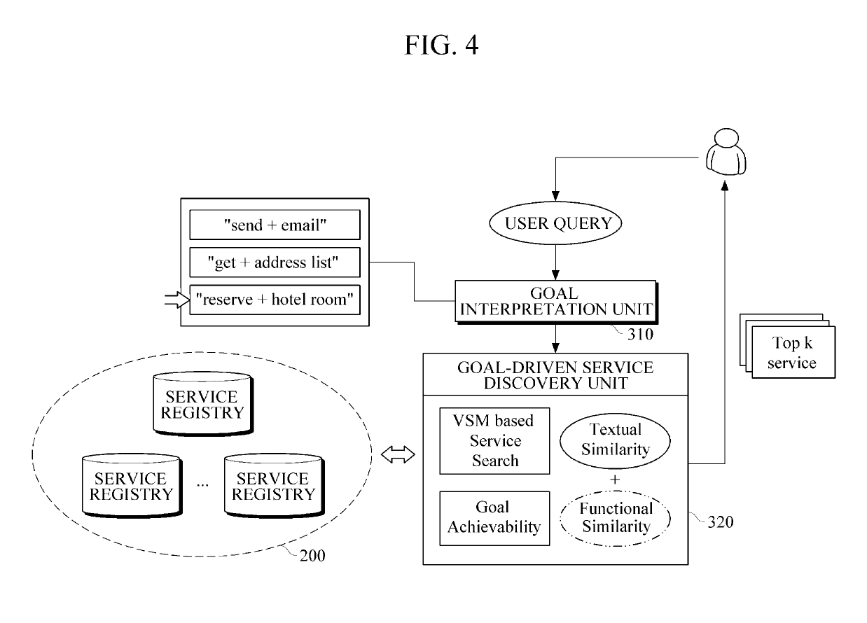

FIG. 4 is a diagram for describing in detail a goal-driven service discovery apparatus according to a preferred embodiment of the present invention.

Referring to FIG. 4, the goal interpretation unit 310 performs interpretation on a goal of a user using a query of the user, and then the goal-driven service discovery unit 320 searches for services corresponding to the goal of the user.

The goal interpretation unit 310 derives a goal of a “verb+noun clause” type, and the goal-driven service discovery unit 320 returns top k services which are finally selected so as to be suitable for the user in accordance with goal achievability based on service search results and functional similarity acquired by calculating textual similarity based on the vector space model (VSM).

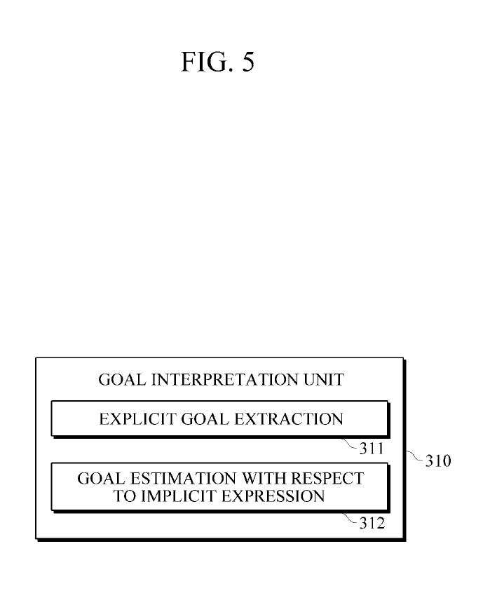

FIG. 5 is a detailed configuration diagram illustrating the goal interpretation unit 310 according to a preferred embodiment of the present invention.

Referring to FIG. 5, the goal interpretation unit 310 includes an explicit goal extraction unit 311 and an implicit goal estimation unit 312 in accordance with difficulty levels of the input query.

The explicit goal extraction unit 311 employs the same technique as an explicit goal part of the adaptive service goal interpreting apparatus 100, but there is a difference therebetween in that a target of goal extraction is query information of the user.

The implicit goal estimation unit 312 performs goal estimation in order to flexibly respond to a case in which an explicit goal with respect to an input goal (or query) of a user cannot be discerned.

In most cases, the user query is composed of a combination of very short words compared to the description parts of the web services. Basically, goal estimation may be performed with respect to implicit expressions in the above-described adaptive goal interpreting apparatus 100; however, expressions are recommended based on a goal ontology which is defined in advance when various goals are provided in accordance with the queries for each user.

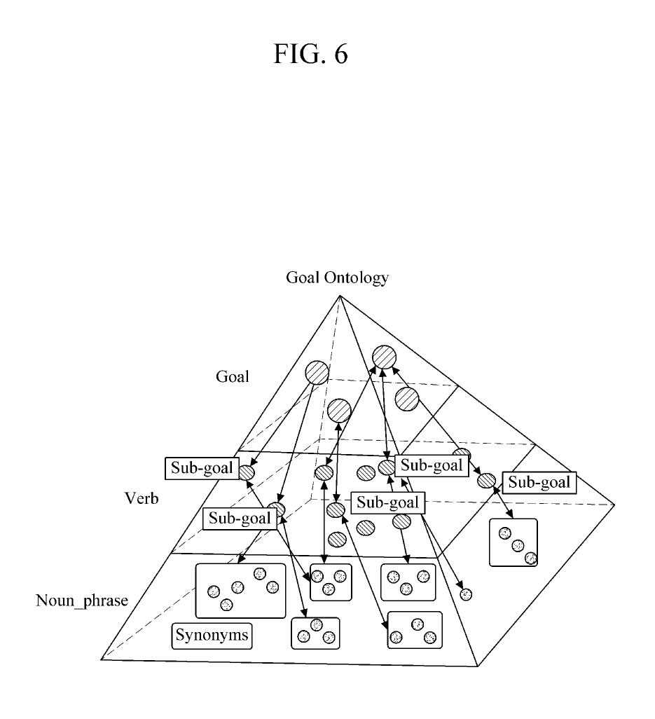

FIG. 6 is a diagram illustrating an example of a goal ontology.

Referring to FIG. 6, the goal ontology is the aggregation of knowledge in which a variety of goals included in short queries of the users are arranged, and is connected to a plurality of sub-goals represented as a “verb+noun clause” type. However, in a goal that is a high-order concept, there may be a plurality of sub-goals associated with the high-order concept or constituting the goal.

A noun clause part includes synonyms, anaphora, and the like, which exist for each domain. The goal ontology is required to be constructed in advance in a manual or semi-automatic manner in accordance with an applied domain.

Accordingly, the results of the implicit goal estimation become a plurality of “verb+noun clauses” acquired from the goal ontology. In order to acquire more accurate goal interpretation results, feedback from a user is required with respect to a plurality of candidates of the goal of the user which exist as interpretation results of explicit/implicit expressions. Consequently, goals which are finally selected by the user may be used as an input of the goal-driven service discovery, which is the next step.

Referring again to FIG. 4, the goal-driven service discovery unit 320 searches each of the service registries 200 to acquire services having high goal achievability. However, it is assumed that services stored in each of the service registries 200 have been subjected to goal interpretation and goal level annotation to thereby be indexed.

For the goal-driven service discovery, service matching based on textual similarity calculated based on the vector space model (VSM) and goal achievability, which means functionality, is performed.

First, query expansion is performed based on the user queries and goal interpretation results, and services are primarily searched based on textual similarity and the expanded queries. This is a process of acquiring services including main keywords by searching using keywords.

Next, goal achievability is calculated with respect to the acquired services. The goal achievability indicates a degree to which a goal level is achieved, when comparing the input goal or query of the user with information which can be directly/indirectly acquired in the description part of the services.

In consideration of diversity of expressions, goal achievability may be considered through lenient matching and strict matching, and this process may be simplified by constructing, in advance, matrixes used in calculating the goal achievability for each expression.

Alternatively, a semantic distance between goals (expressions) that are comparison targets may be calculated through the presented goal ontology.

Services are aligned in order of descending goal achievability, a service having the highest goal achievability is positioned at the top of a result list, and the list is returned as a final result. Obviously, ranking and filtering based on QoS (Quality of Service) which varies with an actual service environment may be additionally considered.

Next, an adaptive service goal interpreting method and a goal-driven semantic service discovery method in the above-described system will be described.

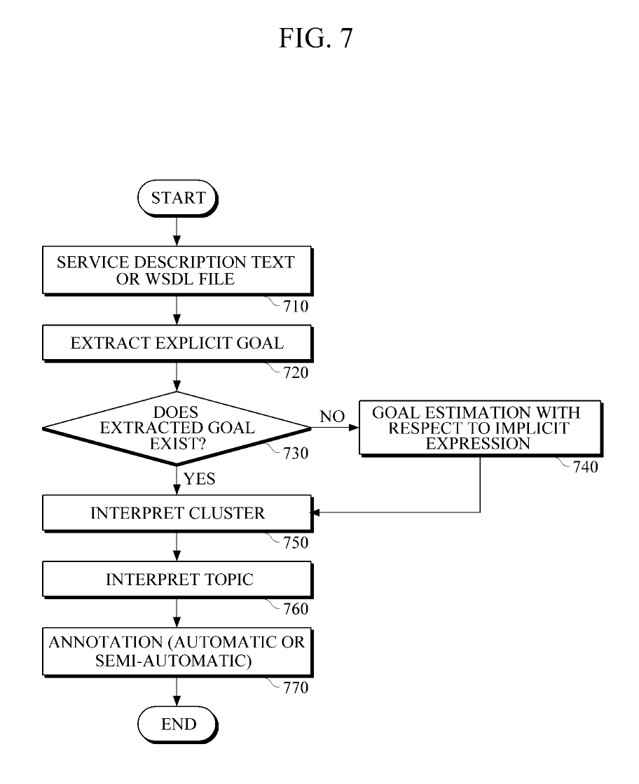

FIG. 7 is a flowchart for explaining an adaptive service goal interpreting method according to a preferred embodiment of the present invention.

Referring to FIG. 7, in step 710, the adaptive service goal interpreting apparatus divides a description part of a WSDL file or service description text into a case in which explicit goal extraction is possible, and a case in which the explicit goal extraction is impossible, and processes the divided part or service description text.

First, in step 720, explicit goal extraction is performed.

Next, in step 730, whether the extracted explicit goal exists is determined.

In step 740, when it is determined that the explicit goal is not extracted based on the determination of step 730, the adaptive service goal interpreting apparatus estimates a goal with respect to implicit expressions and proceeds to step 750. That is, goals are estimated based on main clues.

When the explicit goal is extracted based on the determination of step 730, the adaptive service goal interpreting apparatus proceeds to step 750.

In step 750, the adaptive service goal interpreting apparatus performs cluster interpretation to thereby additionally acquire main goals within a cluster.

Next, in step 760, the adaptive service goal interpreting apparatus selects goals having specific topics based on text contents.

In this manner, the adaptive service goal interpretation is completed, and then the adaptive service goal interpreting apparatus registers service goals of each web service as additional meta-information describing each service in the service registry in step 770. However, goals which are subjected to topic interpretation to thereby be finally selected are directly registered on the service registry as-is, but artificial intervention of a final estimator may be required for maximization of performance.

Here, intervention information may be goals which are finally selected by the final estimator from among a plurality of goals automatically interpreted, or new goals which are not included in the plurality of goals and are additionally annotated by the final estimator.

There still remains room for improving interpretation performance through gradual feedback after constructing a complete automated system.

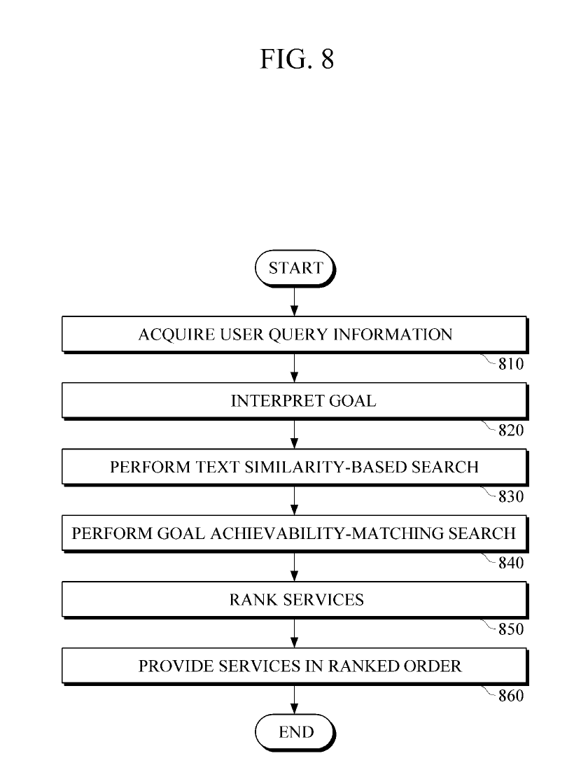

FIG. 8 is a flowchart for explaining a goal-driven semantic discovery method according to a preferred embodiment of the present invention.

Referring to FIG. 8, in step 810, the goal-driven semantic discovery apparatus performs user query to thereby acquire user query information.

In step 820, the goal-driven semantic discovery apparatus interprets a goal based on the user query information. In this instance, although not shown, explicit goal interpretation and implicit goal interpretation may be performed.

Next, the goal-driven semantic discovery apparatus searches for services corresponding to results of the above-described goal interpretation from the service registry. In this instance, the service search is performed during two steps.

Specifically, in step 830, a text similarity-based search is performed using keywords of the goal.

In step 840, a goal achievability-matching search is performed. That is, services detected by the text similarity-based search are further searched for services that match the goal achievability.

In step 850, the goal-driven semantic discovery apparatus ranks the services in accordance with the goal achievability.

In step 860, services are provided in the ranked order.

When the user query is expressed as a more specific goal, the goal of the user is clear, but a description part is not provided based on the goal of the user in web services which actually exist.

Accordingly, in order to search for web services suitable for the goal of the user from among the existing web services, it is necessary to perform a process in which queries are input several times and searching is repeatedly performed, as in general document search.

This problem may intensify with increase in the number of available web services on the Internet, unless the description part of the corresponding service is annotated based on the goal.

As apparent from the above description, according to the present invention, description parts of web services, services, and apps for smart phone which are produced by various service providers are automatically interpreted in terms of goals, and therefore, the goal-driven semantic service discovery is made possible.

In addition, description parts of services having various formats are interpreted using the adaptive interpretation technique to thereby be interpreted in terms of goals of a “verb+noun clause” format. Accordingly, semantic annotation may be more easily performed with respect to the services.

In addition, according to the present invention, the goal-driven service matching in which service goal interpretation is performed with respect to explicit or implicit user query, and then the service matching is performed, is better able to search for services satisfying a goal of a user compared to existing semantic discovery techniques based on keyword search or topics.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An adaptive service goal interpreting apparatus for goal-driven semantic service discovery, comprising:
a goal interpretation unit that interprets a goal of at least one service or application provided on the Web; and
a goal registration unit that registers the goal interpreted by the goal interpretation unit in a service registry.

2. The adaptive service goal interpreting apparatus according to claim 1, wherein the goal interpretation unit includes an explicit goal extraction unit that interprets description text included in the services or the applications to thereby extract an explicit goal represented as a verb+noun clause.

3. The adaptive service goal interpreting apparatus according to claim 2, wherein the explicit goal extraction unit interprets the description text by separating an operation part and a description part included in the description text.

4. The adaptive service goal interpreting apparatus according to claim 2, wherein the explicit goal extraction unit performs interpretation on only a description part of web services in which an operation part is not included.

5. The adaptive service goal interpreting apparatus according to claim 2, wherein the goal interpretation unit further includes an implicit goal estimation unit that estimates a goal implicitly expressed in the description text when the extraction of the explicit goal fails.

6. The adaptive service goal interpreting apparatus according to claim 5, wherein the implicit goal estimation unit acquires at least one word that is paired with an input word using search engines or a corpus of a specific domain with respect the input word, and derives top k words aligned based on a probability when configuring the pair as a result of goal estimation with respect to an implicit expression.

7. The adaptive service goal interpreting apparatus according to claim 2, wherein the goal interpretation unit includes a cluster interpretation unit that classifies services registered in a service registry by each similar service to constitute a cluster, and extracts a representative goal from goals of services existing in each cluster.

8. The adaptive service goal interpreting apparatus according to claim 2, wherein the goal interpretation unit further includes a topic interpretation unit that interprets text in a document to acquire topics of corresponding services.

9. The adaptive service goal interpreting apparatus according to claim 8, wherein the topic interpretation unit classifies the topics by each topic category.

10. The adaptive service goal interpreting apparatus according to claim 8, wherein the topic interpretation unit performs an explicit semantic interpretation method applying a centroid classifier based on a vector-space model, and classifies the topics using a supporting vector machine that is a machine learning method.

11. A goal-driven semantic service discovery apparatus, comprising:
a goal interpretation unit that performs interpretation on a goal of a user based on contents of an input query of the user; and
a goal-driven service discovery unit that searches for services satisfying the goal of the user on which the interpretation is performed from a plurality of service registries.

12. The goal-driven semantic service discovery apparatus according to claim 11, wherein the goal interpretation unit includes an explicit goal extraction unit and an implicit goal estimation unit according to difficulty levels of the input query.

13. The goal-driven semantic service discovery apparatus according to claim 11, wherein the goal interpretation unit executes query expansion based on the input query of the user and a result of the interpretation performed on the goal, and acquires services by text similarity based on the expanded query.

14. The goal-driven semantic service discovery apparatus according to claim 11, wherein the goal interpretation unit calculates goal achievability with respect to the searched services, and searches for the services in accordance with a calculated result.

15. An adaptive service goal interpreting method, comprising:
interpreting goals of web services or applications when a description part of a file or a service description text is provided; and
registering the goals of the web services or the applications in a service registry as additional meta-information describing each of the services or the applications.

16. The adaptive service goal interpreting method according to claim 15, wherein interpreting the goals includes interpreting description text included in the services or the applications to thereby extract an explicit goal represented as a verb+noun clause, and estimating a goal implicitly expressed in the description text when the extraction of the explicit goal fails.

17. The adaptive service goal interpreting method according to claim 15, wherein interpreting the goals further includes performing cluster interpretation to thereby additionally acquire main goals in a cluster.

18. The adaptive service goal interpreting method according to claim 15, further comprising:
selecting goals of a specific topic based on text contents.

19. The adaptive service goal interpreting method according to claim 15, wherein registering the goals includes acquiring intervention information of a final evaluator and registering the acquired intervention information together with the goals of the web services or the applications.
